(19) United States
(12) Patent Application Publication
(10) Pub. No.: US 2010/0042656 A1
(43) Pub. Date: Feb. 18, 2010

(54) CLAIM GENERATION FOR TESTING CLAIMS-BASED APPLICATIONS

(75) Inventors: Vijay K. Gajjala, Sammamish, WA (US); Siddharth Sathish Shenoy, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/193,663

(22) Filed: Aug. 18, 2008

(51) Int. Cl. G06F 17/30

(52) U.S. Cl. 707/200; 707/E17.005

(57) ABSTRACT

The development-time testing of claims based applications. After a claims-based application is deployed, as the application runs, the application will encounter a number of claims, and will perform appropriate processing that depends on the application's trust in the veracity of the those claims. However, at development time, access to claims providers is either limited or non-existent. The principles described herein permit access to an environment at development-time in which the claims-based application will encounter any number and variety of claims. Accordingly, the application may be evaluated to verify proper operation in response to particular claims at development time, and any deviations in expected performance may be addressed prior to deployment.

### BACKGROUND

In computer programming, a “claim” includes a declaration made by an entity (often referred to as an issuer). A declaration is a statement or assertion about an entity (often referred to as a subject). Examples of entities include name, identity, key, group, privilege, capability, and others. For instance, if the subject were a person, the assertion might be that the subject is of a particular age, has a particular country of citizenship, is authorized to act in a certain role (e.g., IT administrator), or any one of many other types of assertions.

Applications may be claims-based in that they may use claims to perform processing. In so doing, after deployment, the application will encounter any number of claims made by one or more issuers. For each claim, the application (or a subsystem acting on behalf of the application) determines whether or not the application trusts the issuer to be making the assertion of the type made in the claim. If the application determines that the issuer is to be trusted, at least within the context of the assertion being made, the application will typically act as though the statement about the subject is true. Otherwise, the application will typically treat the statement about the subject as being unverified. As an example, claims have been used by applications to control access to resources, and/or to personalize processing for a particular client machine or user. For instance, to personalize processing for a particular user, a claim may be made about the user, where the user is the subject of the claim.

The post-deployment operation of a claims-based application thus relies on the availability of claims providers to generate claims issued by reliable issuers.

### BRIEF SUMMARY

Although not required, some embodiments described herein relate to the testing of a claims-based application at development time by providing the claims-based application with an environment in which it receives claims. Thus, the environment simulates an actual environment in which the claims-based application may operate after deployment into its actual working environment. This allows the claims-based application to be more thoroughly tested to verify proper operation in the environment in which it is receiving claims. Also, this may allow claims-based applications to be tested at a lower expense. The environment includes a development-time claims provider, which may be configured to provide assertions of a particular type about a subject.

This Summary is not intended to identify key features or essential features of the claimed subject matter, nor is it intended to be used as an aid in determining the scope of the claimed subject matter.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a computing system in which embodiments described herein may operate;

FIG. 2 illustrates a development environment in which embodiments described herein may be employed;

FIG. 3 symbolically illustrates a data structure of a claim;

FIG. 4 illustrates a flowchart of a method for facilitating development of a claims-based application by causing a claims provider to provide claims to a claims-based application at development time;

FIG. 5 illustrates a flowchart of a method for the claims-based application to respond to receipt of the requested claim at development time; and

FIG. 6 illustrates a flowchart of a method for using claims to develop a claims-based application.

### DETAILED DESCRIPTION

Embodiments described herein relate to the development-time testing of claims based applications. After a claims-based application is deployed, as the application runs, the application will encounter a number of claims, and will perform appropriate processing that depends on the applications trust in those claims. However, at development time, access to claims providers might be either limited or non-existent. The principles described herein permits access to an environment at development-time in which the claims-based application will encounter any number and variety of claims. Accordingly, the application may be evaluated to verify proper operation in response to particular claims at development time, and any deviations in expected performance may be addressed prior to deployment.

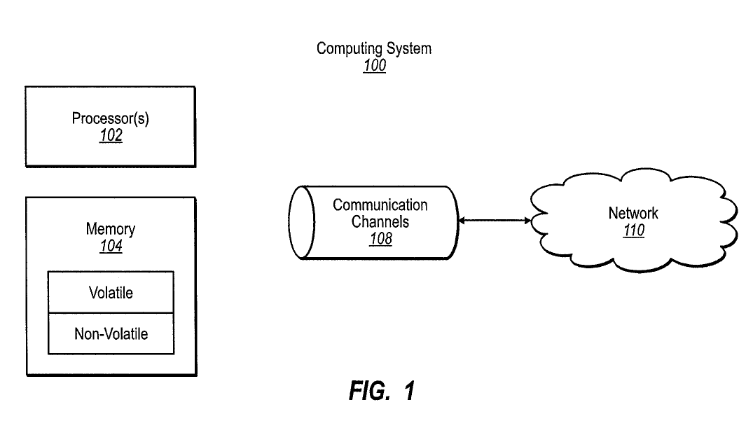

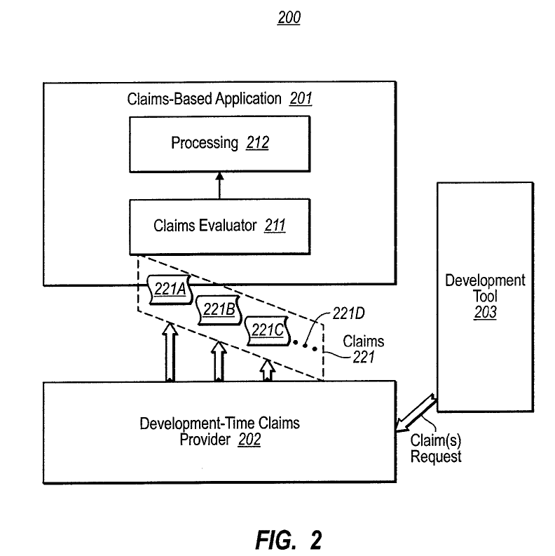

First, some introductory discussion regarding a computing system in which the principles described herein may be employed will be described with respect to FIG. 1. Then, various embodiments of the testing of the claims-based application will be described with respect to FIGS. 2 through 6.

FIG. 1 illustrates a computing system 100. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term “computer-readable media” as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

FIG. 2 illustrates a development environment 200 that includes claims-based application 201 that is under development. Once deployed, the application 201 will operate at least partially in response to claims issued by one or more outside entities. While all of the application's processing may not depend upon claims being made to the application, the application 201 nonetheless will at least sometimes receive claims, and perform processing accordingly. Accordingly, the application 201 will often be referred to as a “claims-based” application.

The development environment 200 allows the claims-based application 201 to be tested by simulating an environment in which the application 201 will be deployed. Specifically, even though the claims-based application 201 is still under development, a development-time claims provider 202 is included in the environment. The development time claims provider 202 issues claims 221 to the claims-based application 201, thereby allowing a developer to monitor how the claims-based application 201 will actually respond to particular claim, and if appropriate, make corrections. In FIG. 2, the claims 221 are illustrated as including three claims 221A, 221B and 221C. However, the ellipses 221D symbolically represents that the claims provider 202 may provide more or less than this number of claims.

In one embodiment, the number and type of claims provided by the claims provider 202 is configurable. This is particularly advantageous as it allows the developer to control the type of claims received by the claims-based application 201, thereby controlling the scenario that the application 201 is tested against. This configuration of the type of claims, and even the timing of the claims may be provided by the development tool 203. The development tool 203 may be software that is separate from the claims-based application 201 under development. Alternatively or in addition, the development tool 203 may be integrated with the claims-based application 201 itself.

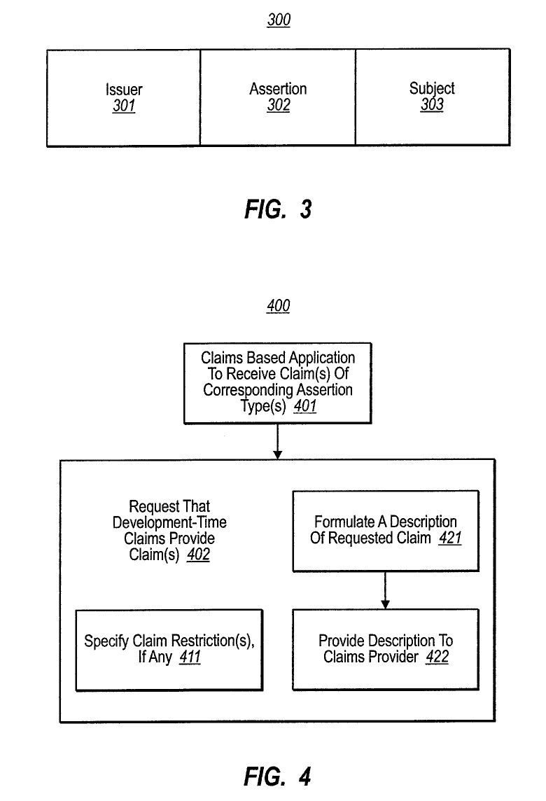

Before describing embodiments of the testing process in further detail, a data structure of a claim will be described with reference to the example claim data structure 300 of FIG. 3. A claim includes essentially three components, an issuer 301, an assertion 302, and a subject 303. A claim might include other data fields as well. Furthermore, the claim need not specify the issuer 301, the assertion 302 and the subject 303 in the order shown in FIG. 3 in the order illustrated in FIG. 3, so long as the claim is expressed in a schema understood by the claims-based application that interprets the claim. The issuer 301 may be the same entity as or a different entity than the subject 303 of the claim 300.

FIG. 4 illustrates a flowchart of a method 400 for facilitating development of a claims-based application. The method 400 may be performed in the environment 200 of FIG. 2. Accordingly, the method 400 will be described with frequent reference to the environment 200. The method 400 may be performed by a computing system (such as computing system 100 of FIG. 1) in response to the execution by one or more processors (such as processors 102 of FIG. 1) of computer-executable instructions that are present in memory or storage (such as memory 104 of FIG. 1).

Referring to FIG. 2, the method 400 may be performed by the claims-based application 201 or may be performed by the development tool 203. The method 400 is performed in response to a determination (act 401) that the claims-based application should receive a claim of a particular assertion type regarding a particular subject in order to test the claims-based application. There is an unlimited variety of assertion types that could be made. As an example only, one assertion type might be an age assertion (e.g., the subject is 25 years old), a citizenship assertion (e.g., the subject is an American citizen), an authority assertion (e.g., the subject is authorized act on behalf of the president), a payment assertion (e.g., the subject has paid an amount), a credit assertion (e.g., the subject is authorized to charge to this account), or any other conceivable assertion type. Each assertion type has a plurality of possible values, where the validity of the values might depend on a particular system. For instance, for a citizenship assertion type, the possible data set might include a country identifier for all or a subset of the world's countries. For an age assertion type, any integer from zero to perhaps 255 might be considered valid. Other systems might consider perhaps zero to 99 valid numbers of an age assertion. Some assertion types such as the payment assertion may have just a simply Boolean value of “yes” or “no”.

The method 400 also includes requesting (act 402) that a development-time claims provider provide a claim having an assertion of the requested particular type about a subject to the claims-based application. In FIG. 2, for example, the claims-based application 201 itself, or perhaps the development tool 203 (either being referred to as a “requester” hereinafter when discussed in their potential role as a requester of a claim) requests that the claims provider 202 provide the claim of the requested assertion type regarding the particular subject.

The request may be represented in one single communication to the claims provider, or may be done via multiple communications to the claims provider 202, perhaps even extended in time. For instance, in the single communication type, the requestor may simply specify that a claim of a particular assertion type is desired. The request may also indicate one or more values for the assertion type.

In the case of a single value, the claims provider may provide a single claim having the assertion type that specifies the value. For instance, perhaps the claims provider is instructed to provide an age assertion about a subject and that the value of the assertion is to be 29. The claims provider may then issue a single claim specifying itself as the issuer and that the subject is 29 years old.

In the case of multiple values, the claims provider may provide multiple claims each having a corresponding value. For example, if the corresponding data values are 5, 13, 19, 25 and 45 and the assertion type is age-based. The claims provider may output multiple claims on behalf of the issuer as follows: 1) the subject is 5 years old, 2) the same subject is 13 years old, 3) the same subject is 19 years old, 4) the same subject is 25 years old, 5) the same subject is 45 years old. Note that these claims are entirely inconsistent when viewed collectively. A subject can only be a single age. However, for purposes of development, the developer can now see how the claims-based application will react to these various claims. Since the issuer is the same, the claims-based application will treat each claim as being true, even though they are inconsistent. Accordingly, the claims-based application may be verified to take appropriate action for a wide variety of claims, and may trust claims regardless of whether the claims are actually factual, and even in cases in which the claims are internally inconsistent.

The request for claim(s) may also be provided in multiple communications from the requestor to the claims provider. For instance, the claims provider may be first instructed by the requestor (perhaps well in advance) to provide a certain set of one or more data values whenever a claim having a particular assertion type is requested. For instance, in the example above, the claims provider may be instructed (e.g., through policy or through some other description) to provide ages 5, 13, 19, 25 and 45 in separate claims regarding a subject in response to each request for claims having an age-based assertion type. As another example, of the assertion type has a Boolean value, the claims provider may be instructed in advance to provide two claims, one asserting a false value, and one asserting a true value, even with respect to the same claim. This is internally inconsistent, but the claims-based application may treat both as true, or both as false, for purposes of testing.

In one embodiment, the request is made to include (act 411) additional restrictions for the requested claims. For instance, in the claim of multiple claims being emitted in response to a request, the restrictions might indicate a minimum time between claim emissions. There might also be conditions attached to the claims emissions. For instance, perhaps a claim is made to make a claim of one assertion type if a memory location has a certain value, and another assertion type if the memory location has another value.

The request may be made by formulating (act 421) a description of at least one claim that is to be provided to the claims-based application at development time. This description may be made using a schema that is understood by the claims provider. Furthermore, the description is then provided (act 422) to the development-time claims provider.

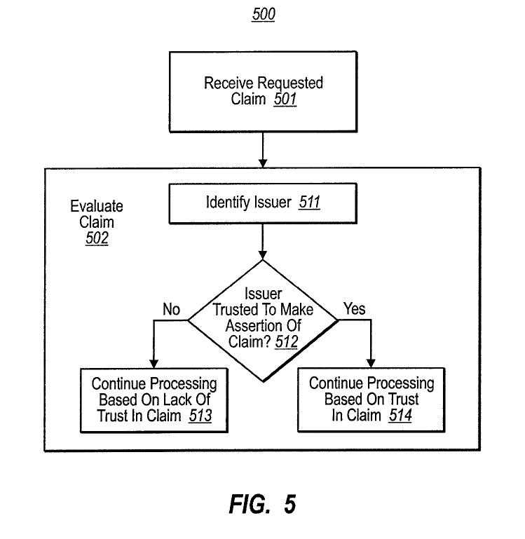

FIG. 5 illustrates a flowchart of a method 500 for responding to the receipt of a requested claim. This method 500 may be performed by the claims-based application 201 of FIG. 2 each time the application 201 receives a claim from the development-time claims provider 202. Referring to FIG. 3, recall that a claim is an assertion of the requested assertion type about a particular subject made by an issuer. As an example, the claim may be included as part of a security token, in which case the development-time claims provider 202 may be a security token provider.

Upon receiving a claim (act 501) from the claims provider, the claims-based application evaluates (act 502) the requested claim to determine whether (for testing purposes) an issuer of the requested claim is trusted by the claims-based application to make the assertion. This may be accomplished by identifying (act 511) the issuer by reading the issuer identifier in the claim. The application may then determine (act 512) whether the issuer is trusted to make assertions of the type made in the claim, and continue processing (act 513) based on a result of the determination. In one embodiment, the claims provider may be configured to make claims on behalf of one issuer who is trusted by the claims-based application, and another issuer who is not trusted by the claims-based provider. This allows the developer to test the claims-based application for situations in which the claim is not trusted as well.

In one embodiment, the issuer that is trusted by the claims-based application is trusted for purposes of development only. Once the application is developed, the developer may change a setting in the application that causes the application to no longer trust the development-time issuer. This is advantageous since the development-time issuer does not reliably make true statements, but rather sometimes intentionally makes false statements for testing purposes only. After deployment, however, claims-based application function best when they trust claims when there is a reasonable basis for believing the issuer reliably makes true claims.

There is no limit to the variety of configurations that the development-time claim provider may have. To illustrate the variety of such configurations, three examples will be provided. However, these examples should be viewed as illustrative of the wider variety of configurations for the claims provider.

In one embodiment, the development-time claims provider includes a user interface that allows the developing user to enter at least some of the information in the claim. For instance, the developer might enter claims that identify the issuer for purposes of making one or more claims about the subject. The developer might also enter the assertion type and/or a data value for the assertion into perhaps a form. Upon completing the form, the entered data may be used to populate some or all of the data fields of the claim. The claims provider would then provide the claim to the claims-based application.

In a second example, the claims provider may automatically generate the requested claims without user intervention and based only on information in the request, or other data available to the claims provider. For instance, a developer may have published policy information that specifies what data values are to be provided in particular assertion types. Once a request is received for a claim of the assertion type, the claims provider may automatically generate one or more claims without further user intervention.

In a third example, the development-time claims provider may be a security token service that is configured to provide the claim in a form of a security token. The security token provider may provide claims in the form of security tokens for purposes of development of an application,. If the claim is for development only, the claims provider may remove the typical guarantees to ensure the truth of the claim made. This is because the truth of the claim made to an application under development is not as important as verifying the proper operation of the claims-based application in response to the claim.

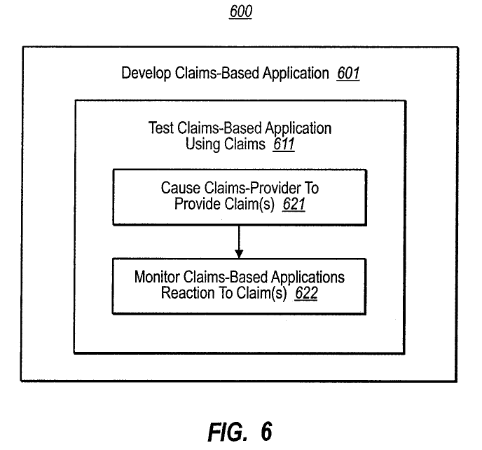

FIG. 6 illustrates a flowchart of a method 600 for developing a claims-based application. The larger act includes developing a claims-based application (act 601). This act may be performed, for example, by a developer authoring a claims-based computer program. Developing applications involves various iterations of drafting code, compiling code, and testing the code for proper operation. Accordingly, the act of developing the claims-based application (act 601) includes an act of testing the claims-based application under development (act 611). This act of testing includes causing an external development-time claims provider to generate a claim having an assertion of a particular assertion type, and having an issuer that is used primary at development time (act 621). For instance, the developer might cause the claims requester (i.e., the application under development or the development tool) to request that the claims provider provide a particular claim. The methods 400 and 500 of FIGS. 4 and 5 are then performed. The developer then monitors how the claims-based application under development responds to the processing of the generated claim (act 622).

Accordingly, the principles described herein allow a claims-based application to be tested in an environment in which claims are actually supplied to the claims-based application. This allows a developer to monitor the behavior of the claims-based application in an environment closer to the environment in which the application will operate after deployment. It also gives the developer an opportunity to correct any errors found before deployment resulting in a better product at deployment.

present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by the United States Letters Patent is:

1. A computer program product comprising one or more computer-readable media having thereon one or more computer-executable instructions that, when executed by one or more processors of a computing system, cause the computing system to perform a method for facilitating development of a claims-based application, the method comprising:
an act of determining that a claims-based application should receive a claim of a particular assertion type regarding a particular subject in order to testing the claims-based application; and
an act of requesting that a development-time claims provider provide a claim having an assertion of a particular type about a subject to the claims-based application.

2. A computer program product in accordance with claim 1, wherein the one or more computer-readable media is or are physical memory and/or storage media.

3. A computer program product in accordance with claim 2, wherein the method is performed by the claims-based application such that the computer-executable instructions are part of the claims-based application.

4. A computer program product in accordance with claim 3, wherein the one or more computer-executable instructions are further structured such that the method further comprises:
upon detecting receipt of the requested claim, the requested claim including an assertion of the particular assertion type about the particular subject and made by an issuer, an act of evaluating the requested claim to determine whether an issuer of the requested claim is trusted by the claims-based application for purposes of developing the claims-based application to make the assertion.

5. A computer program product in accordance with claim 4, wherein the issuer is trusted by the claims-based application for purposes of developing the claims-based application, but not for purposes of executing the claims-based application after development of the claims-based application.

6. A computer program product in accordance with claim 2, wherein the method is performed by development software apart from the claims-based application such that the computer-executable instructions are part of the development software.

7. A computer program product in accordance with claim 2, wherein the issuer is different than the subject of the requested claim.

8. A computer program product in accordance with claim 2, wherein the act of requesting that a development-time claims provider provide a claim having an assertion of a particular type about a subject to the claims-based application comprises:
an act of formulating a description of at least one claim that is to be provided to the claims-based application at development time; and
an act of providing the description to the development-time claims provider.

9. A computer program product in accordance with claim 2, wherein the development-time claims provider includes a user interface for allowing a user to enter data that is to be used to generate the claim.

10. A computer program product in accordance with claim 2, wherein the development-time claims provider automatically generates the requested claim without user intervention.

11. A computer program product in accordance with claim 2, wherein the development-time claims provider provides claims in the form of security token service that is configured to provide development-time security tokens.

12. A computer program product in accordance with claim 11, wherein the security token services provides security tokens that include claims to the claims-based application in response to the act of requesting.

13. A computer program product in accordance with claim 12, wherein the computer-executable instructions are further structured such that the act of requesting further comprises:
an act of specifying additional restrictions for the requested claim in addition to the assertion type and the subject.

14. A computer program product in accordance with claim 12, wherein the computer-executable instructions are further structured such that the act of requesting further comprises:
an act of specifying that a plurality of claims of the assertion type are to be provided.

15. A computer program product in accordance with claim 14, wherein the computer-executable instructions are further structured such that the act of requesting further comprises:
an act of specifying an array of data values that are to be provided for the plurality of claims of the assertion type.

16. A computer program product comprising one or more computer-readable media having thereon one or more computer-executable instructions that, when executed by one or more processors of a computing system, cause the computing system to perform a method for a claims-based application to operate using claims during development-time of the claims-based application, the method comprising:
an act of detecting receipt of a claim issued from a development-time claims provider, wherein the claim specifies an assertion, a subject of the assertion, and an issuer of the assertion;
an act of identifying the issuer based on the identification of the issuer specified in the claim;
an act of determining whether the issuer is trusted to make assertions of the type made in the claim; and
an act of continuing processing based on a result of the determination.

17. A computer program product in accordance with claim 16, wherein the one or more computer-readable media is or are physical memory and/or storage media.

18. A method for developing a claims-based application comprising:
an act of developing a claims-based application;
while performing the act of developing a claims-based application, an act of testing the claims-based application under development, wherein the act of testing comprises:
an act of causing an external development-time claims provider to generate a claim having an assertion of a particular assertion type, and having an issuer that is used primary at development time; and
an act of monitoring how the claims-based application under development responds to the processing of the generated claim.
